(19) United States
(12) Patent Application Publication
(10) Pub. No.: US 2007/0132749 A1
(43) Pub. Date: Jun. 14, 2007

(54) Systems for controlling brightness of displayed images

(75) Inventors: Du-Zen Peng, Jhubei City (TW); Shih-Chang Chang, Jhudong Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Toppoly Optoelectronics Corp.

(21) Appl. No.: 11/299,707

(22) Filed: Dec. 12, 2005

(51) Int. Cl. G09G 5/00

(52) U.S. Cl. 345/207

(57) ABSTRACT

Systems for controlling brightness of displayed images of a display panel are provided. A representative system incorporates a control unit that is operative to adjust brightness of a corresponding display panel based upon at least one of: detected brightness of ambient light and brightness of light emitting elements of the display panel.

### BACKGROUND

The disclosure relates to image display.

Display panels of mobile electronic systems are typically user adjustable to compensate for varying levels of environmental brightness. For example, a display panel should be able to generate high brightness to display an image in a bright environment. Conversely, the display of a dark image in a darker environment requires less display panel brightness.

A conventional method controls brightness of light emitted from a display panel according to voltage generated by a voltage divider. FIG. 1 is a schematic diagram of a conventional voltage divider. A voltage between two resistors can be adjusted according to the resistance of two resistors. A first maximum gray level provided by voltage divider 10 is 100 nits, a second maximum gray level provided by voltage divider 12 is 150 nits, and a third maximum gray level provided by voltage divider 14 is 200 nits. Therefore, the brightness of light emitted from the display panel can be adjusted by providing different maximum gray levels. Unfortunately, since such a conventional method utilizes numerous voltage dividers to generate multiple voltages for adjusting the brightness of light emitted from the display panel, the cost and size of the display panel can be high.

### SUMMARY

Systems for controlling brightness of displayed images are provided. In this regard, a representative embodiment of such a system comprises a signal generator that comprises a control unit, a first processing unit, and a storage unit. The control unit outputs a reference voltage according to the brightness of light emitted from the lamp during a first period and outputs a reference signal during a second period. The first processing unit comprises a first input terminal and a first output terminal. Voltage of the first input terminal is equal to that of the first output terminal during the first period. A logic level of the first output terminal is inverse to a logic level of the first input terminal. The storage unit stores a response voltage according to the reference voltage and the voltage of the first input terminal during the first period and controls the logic level of the first input terminal according to the reference voltage and the response voltage during the second period.

Another embodiment of such a system comprises a control unit that is operative to adjust brightness of a corresponding display panel based upon at least one of: detected brightness of ambient light and brightness of light emitting elements of the display panel.

### BRIEF DESCRIPTION OF THE DRAWINGS

The invention can be more fully understood by reading the subsequent detailed description and examples with reference made to the accompanying drawings, wherein:

FIG. 1 is a schematic diagram of a conventional voltage divider;

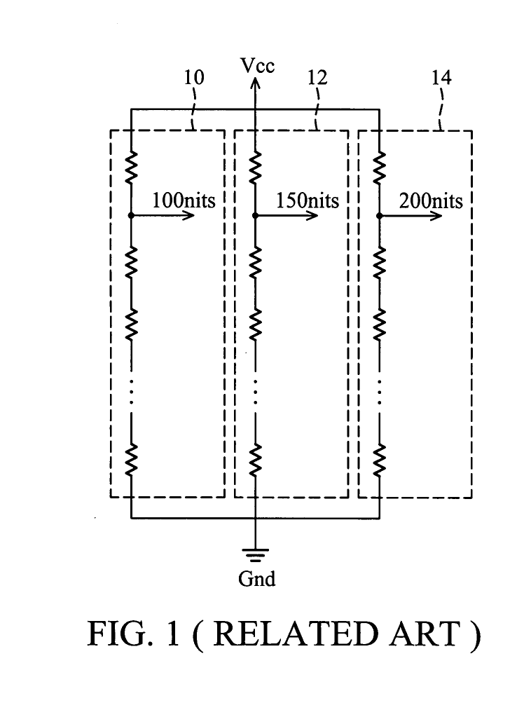

FIG. 2a is a schematic diagram of an embodiment of a system for controlling brightness of displayed images;

FIG. 2b is a schematic diagram of the embodiment of FIG. 2a, showing the signal generator in greater detail:

FIG. 3 is a timing diagram of the preset signal STV shown in FIG. 2b;

FIG. 4 is a schematic diagram of another exemplary embodiment of a system for controlling brightness of displayed images;

FIG. 5 is a timing diagram of the preset signal STV shown in FIG. 2c;

FIG. 6 is a schematic diagram of another embodiment of a system for controlling brightness of displayed images:

FIG. 7 is a schematic diagram of an embodiment of a pixel; and

FIG. 8 is a schematic diagram of another embodiment of a pixel.

### DETAILED DESCRIPTION

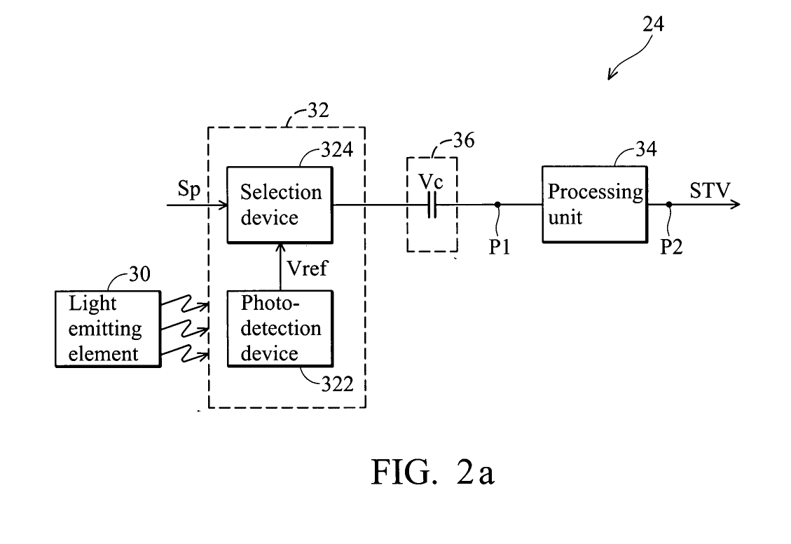

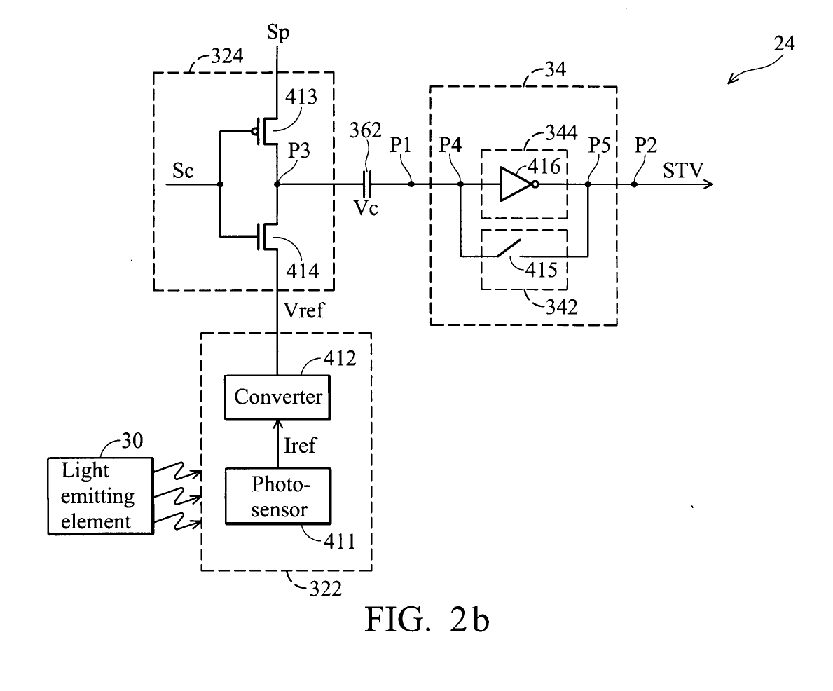

Systems for controlling brightness of displayed images are provided. In this regard, an exemplary embodiment of such a system is depicted schematically in FIG. 2a. As shown in FIG. 2a, the system incorporates a signal generator 24. Signal generator 24 comprises a control unit 32, a first processing unit 34, and a storage unit 36 connected therebetween.

During a first period, control unit 32 outputs a reference voltage Vref according to brightness emitted from light-emitting element 30. During a second period, control unit 32 outputs a reference signal Sp. Control unit 32 comprises a photo-detection device 322 and selection device 324. Photo-detection device 322 provides reference voltage Vref according to the brightness of light emitted from lamp 30. Selection device 324 outputs reference voltage Vref or reference signal Sp according to a control signal Sc (not shown). In this embodiment, the logic level of control signal Sc is high during the first period and that of control signal Sc is low during the second period. Therefore, selection device 324 outputs reference voltage Vref during the first period and outputs reference signal Sp during the second period. In this embodiment, reference signal Sp is a triangular signal provided from external.

The first processing unit 34 comprises an input terminal P1 and an output terminal P2. A voltage of the input terminal P1 is equal to that of the output terminal P2 during the first period. Additionally, a logic level of the output terminal P2 is inverse to a logic level of the input terminal P1 during the second period.

Storage unit 36 stores a response voltage Vc according to reference voltage Vref and the voltage of the input terminal P1 during the first period. Additionally, storage unit 36 controls the logic level of the input terminal P1 according to reference voltage Vref and the response voltage Vc during the second period. The output terminal P2 provides preset signal STV according the logic level of the input terminal P1 during the second period. In this embodiment, storage unit 36 is a capacitor.

FIG. 2b is a schematic diagram of the embodiment of the system for controlling brightness of displayed images of FIG. 2a showing the signal generator 24 in greater detail. In this regard, photo-detection device 322 comprises a photo-sensor 411 and a converter 412 and provides reference voltage Vref according to brightness of light emitted from light-emitting element 30. Photo-sensor 411 detects the brightness of light emitted from light-emitting element 30 and provides a corresponding current Iref. Converter 412 converts the current Iref to reference voltage Vref. Since a value of the current Iref is small, a current mirror unit (not shown) is utilized to amplify the current Iref. Converter 412 receives the amplified current Iref. Additionally, an amplifier (not shown) can be utilized for amplifying reference voltage Vref. Selection device 324 comprises transistors 413 and 414. Transistor 413 is a P-type transistor and transistor 414 is an N-type transistor. A source of transistor 413 receives reference signal Sp, a gate thereof receives a control signal Sc, and a drain thereof is coupled to a drain of transistor 414. A gate of transistor 414 receives the control signal Sc and a source thereof receives reference voltage Vref.

As the control signal Sc is at high logic level during the first period, transistor 414 is turned on. Therefore, voltage of a node P3 is approximately equal to reference voltage Vref. As the control signal Sc is at low logic level during the second period, transistor 413 is turned on. Therefore, voltage of a node P3 is approximately equal to voltage of reference signal Sp.

The first processing unit 34 comprises a switching device 342 and an inverting device 344 connected in parallel with switching device 342. During the first period, switching device 342 is turned on such that a voltage of an input terminal P4 of inverting device 344 is equal to that of an output terminal P5 of inverting device 344. During the second period, switching device 342 is turned off such that a logic level of the output terminal P5 is the inverse of the input terminal P4. In some embodiments, inverting device 344 can be an inverter 416 and switching device 342 can be a switch 415.

To increase a sensitivity of inverting device 344, inverting device 344 can include inverters connected in series, with a switch being coupled between an input terminal of a first of the inverters and an output terminal of a last inverters. Additionally, inverting device 344 can comprise a plurality of inverters connected in series, with a plurality of switches, each connected in parallel with one of the inverters. Since inverting device 344 has an inverse function during the second period, the number of inverters should be odd.

In the embodiment of FIG. 2b, photo-sensor 411 detects brightness of light emitted from light-emitting elements of a display panel. Since the light-emitting elements age, the brightness of light emitted from the light-emitting elements typically will decay. Thus, signal generator 24 can compensate for the decaying brightness due to aging of light-emitting elements.

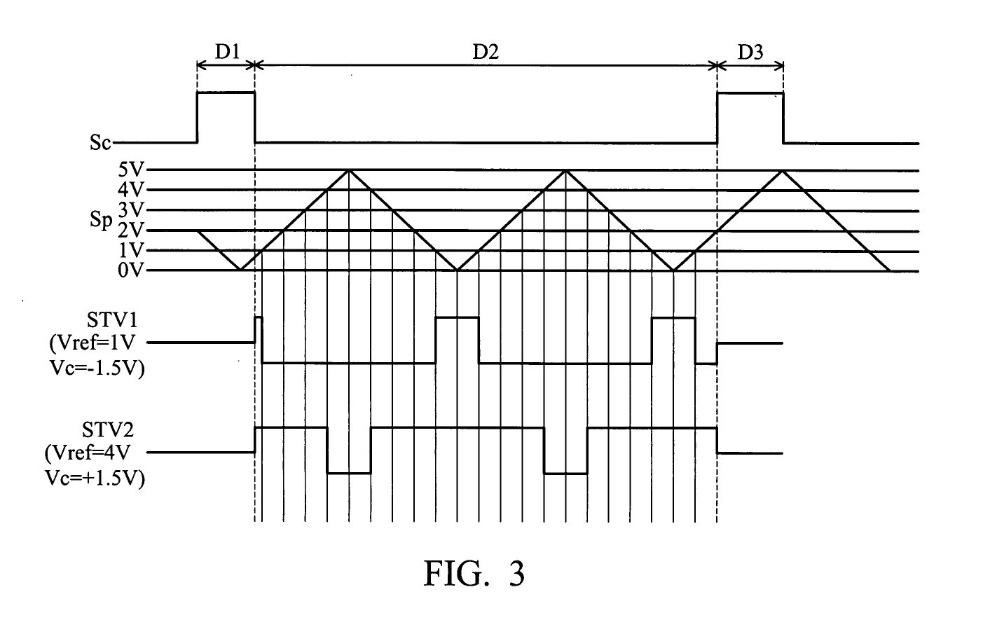

The operating principle of the system shown in FIG. 2b is described in the following. In this regard, FIG. 3 is a timing diagram of the preset signal STV of FIG. 2b. Assuming the high voltage of inverter 416 is equal to 5V and low voltage thereof is equal to 0V, then during a first period D1, switch 415 is turned on such that voltages of nodes P4 and P5 are equal to 2.5V. Therefore, preset signal STV1 approximately equals 2.5V.

During first period D1, control signal Sc is at a high logic level such that transistor 414 is turned on. Therefore, voltage of node P3 equals reference voltage Vref. If the brightness of light emitted from light-emitting elements of a display panel changes from bright to dark, the reference voltage Vref output from photo-detection device 322 is equal to 1V. When voltage V_{P4} of node P4 equals 2.5V and voltage V_{P3} of node. P3 equals 1V, the voltage Vc of capacitor 362 equals −1.5V.

During the second period, control signal Sc is at a low logic level such that transistor 413 is turned on. Therefore, the voltage V_{P3} is equal to reference signal Sp. Reference signal Sp is a triangular signal in this embodiment having a maximum voltage equal to 5V and a minimum voltage equal to 0V. Since voltage Vc equals to −1.5V, when voltage V_{P3} is less than 1V, preset signal STV1 is at a high logic level, and when voltage V_{P3} is more than 1V, preset signal STV1 is at a low logic level.

During the third period D3, switch 415 is turned on such that voltages of nodes P4 and P5 are equal to 2.5V. Therefore, preset signal STV1 is equal to 2.5V and voltage Vc will be changed according to reference voltage Vref.

If the brightness of light emitted from light-emitting elements of a display panel changes from dark to bright, the reference voltage Vref output from photo-detection device 322 is equal to 4V. When voltage V_{P4} of node P4 equals 2.5V and voltage V_{P3} of node P3 equals to 4V, voltage Vc of capacitor 362 equals 1.5V.

During the second period, control signal Sc is at a low logic level such that transistor 413 is turned on. Therefore, the voltage V_{P3} equals reference signal Sp. Since voltage Vc equals 1.5V when voltage V_{P3} is less than 4V, preset signal STV2 is at a high logic level, and when voltage V_{P3} is more than 4V, preset signal STV2 is at a low logic level.

During the third period D3, switch 415 is turned on such that voltages of nodes P4 and P5 are equal to 2.5V. Therefore, preset signal STV2 is equal to 2.5V and voltage Vc will be changed according to reference voltage Vref.

As shown in FIG. 3, when the brightness emitted from light-emitting elements of a display panel changes, reference voltage Vref output from photo-detection device 322 changes to adjust a duty cycle of preset signal STV.

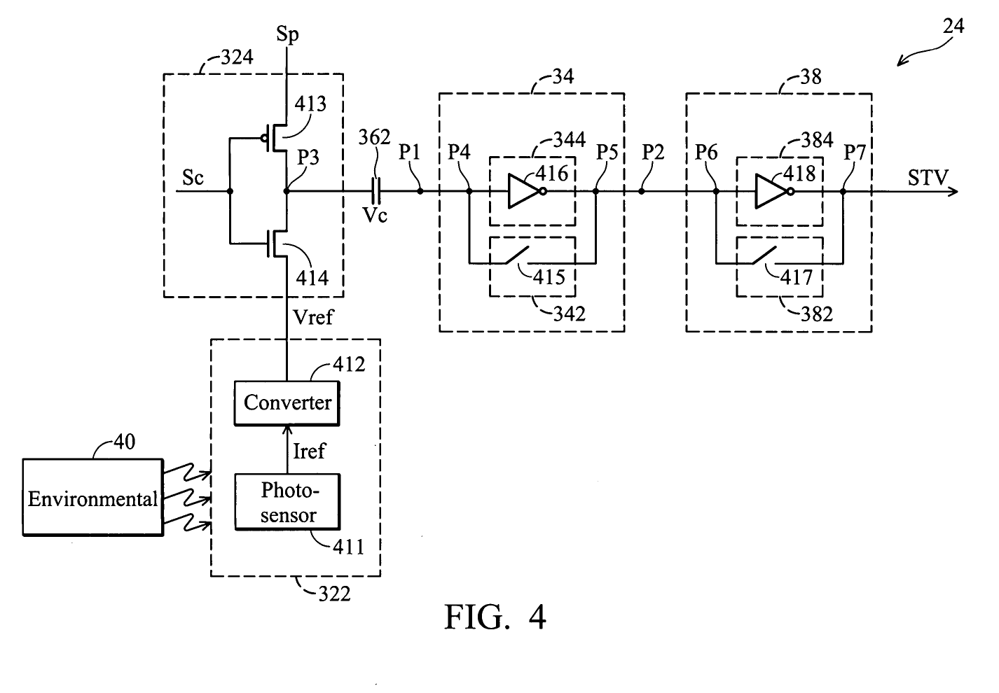

FIG. 4 is a schematic diagram of another exemplary embodiment of a system for controlling brightness of displayed images. FIG. 4 is similar to the embodiment of FIG. 2b except that a second processing unit 38 is coupled to first processing unit 34. In this embodiment, the first processing unit 38 comprises a switching device 382 and an inverting device 384 connected in parallel with switching device 382. During the first period, switching device 382 is turned on such that a voltage of an input terminal P6 of inverting device 384 is equal to that of an output terminal P7 of inverting device 384. During the second period, switching device 382 is turned off such that a logic level of the output terminal P7 is the inverse of the input terminal P6. In some embodiments, inverting device 384 can be an inverter 418 and switching device 382 can be a switch 417.

To increase a sensitivity of inverting device 384, inverting device 384 can include inverters connected in series, with a switch coupled between an input terminal of a first of the inverters and an output terminal of a last of the inverters. Additionally, inverting device 384 can comprise a plurality of inverters connected in series, and a plurality switches, each connected in parallel to one of the inverters. Since inverting device 384 has an inverse function during the second period, the number of inverters should be odd. The number of inverters of inverting devices 344 and 384 preferably is even.

In the embodiment of FIG. 4, photo-sensor 411 detects environmental brightness (ambient light). The brightness perceived by a viewer of the display panel that is lower if the environmental brightness is high. Therefore, the brightness of light emitted from the light-emitting elements of a display panel is directly proportional to environmental brightness.

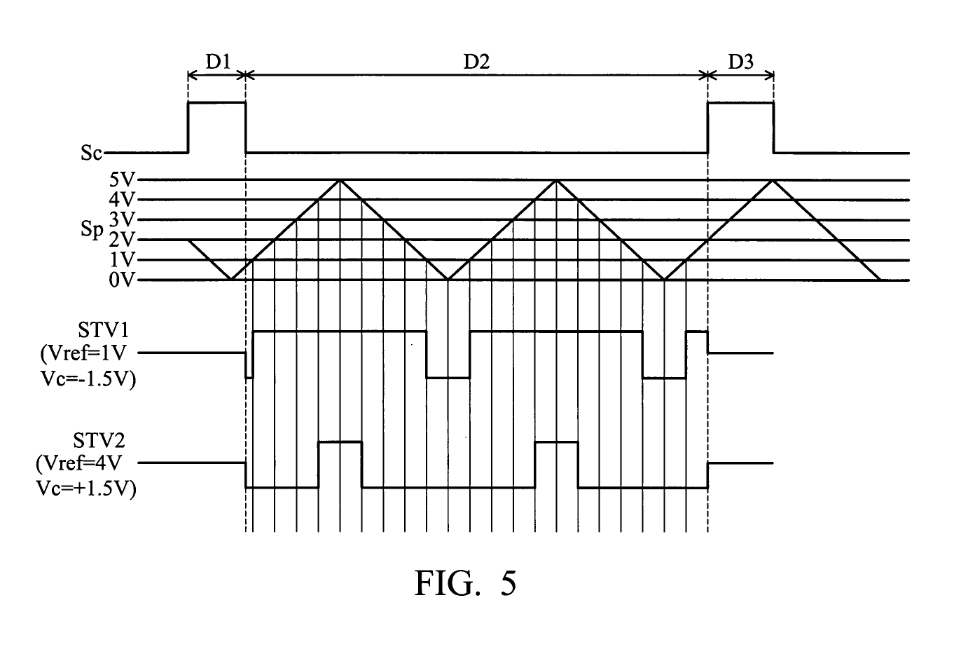

FIG. 5 is a timing diagram of the preset signal STV of FIG. 4. Since signal generator 24 shown in FIG. 4 detects environmental brightness, preset signals STV1 and STV2 are generated accordingly. Preset signal STV1 is generated when environmental brightness is high. Preset signal STV2 is generated when environmental brightness is low.

Additionally, since the signal generator shown in FIG. 4 comprises second processing unit, the preset signals STV1 and STV2 shown in FIG. 5 are inverse to the preset signals STV1 and STV2 shown in FIG. 3.

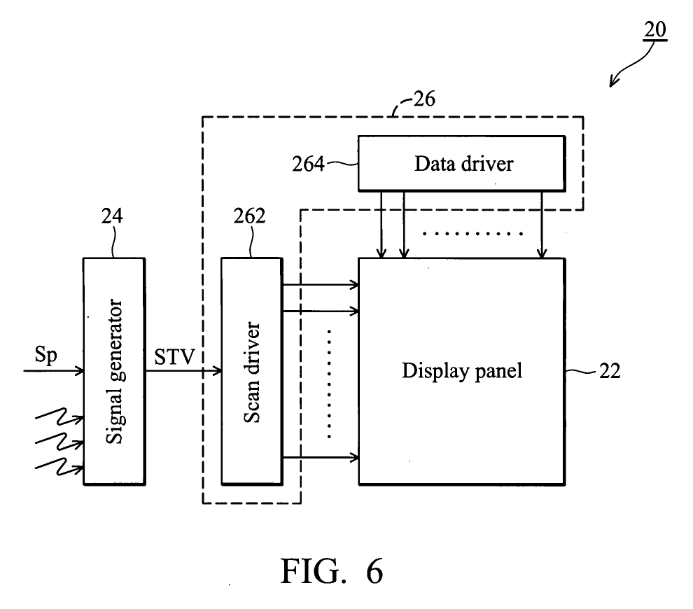

FIG. 6 is a schematic diagram of another embodiment of a system for controlling brightness of displayed images. In this embodiment, system 20 comprises a display panel 22, a signal generator 24, and a driving device 26. Display panel 22 comprises a plurality of light-emitting elements (not shown). Generally display panel 22 is a liquid crystal display panel although in other embodiments, the panel could be an electroluminescent display panel for example. If display panel 22 is a liquid crystal display panel, the light-emitting elements of display panel 22 are string lamps. If display panel 22 is an electroluminescent display panel, the light-emitting elements of display panel 22 are electroluminescent elements.

Signal generator 24 generates a preset signal STV according to brightness of light such as environmental light or light from a light-emitting element. Driving device 26 comprises a scan driver 262 and a data driver 264. Driving device 26 adjusts brightness of light emitted from the light-emitting elements according to preset signal STV.

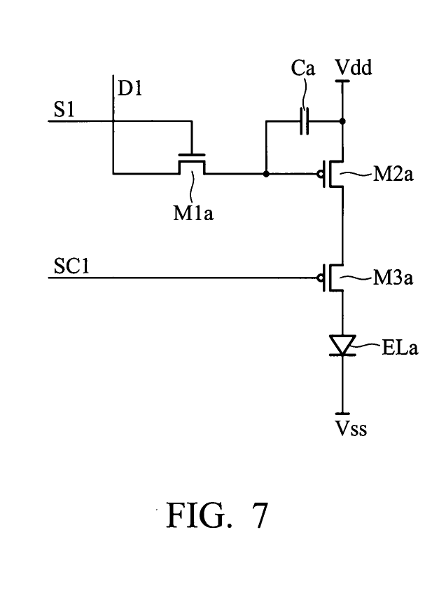

If display panel 22 is an electroluminescent display panel, display panel 22 comprises a plurality of pixels. Each pixel comprises an electroluminescent element. In this regard, FIG. 7 is a schematic diagram of an embodiment of a pixel. For clarity, only one pixel is shown.

When scan driver 262 asserts scan signal S1, a transistor M1a is turned on such that a capacitor Ca is charged according to a data signal D1 provided from data driver 264. As the voltage stored in capacitor Ca is sufficient to turn on a transistor M2a, high voltage Vdd can be output to a transistor M3a.

If driving signal SC1 provided by scan driver 262 is at a high logic level, transistor M3a is turned off such that electroluminescent element ELa does not emit light. If driving signal SC1 is at low logic level, transistor M3a is turned on such that electroluminescent element ELa emits light.

When the turn-on time of the transistor M3a is longer, luminiferous time of electroluminescent element ELa is longer such that brightness emitted from display panel 22 is brighter. When the turn-on time of transistor M3a is shorter, luminiferous time of electroluminescent element ELa is shorter such that brightness emitted from display panel 22 is less. Therefore, a duty cycle of preset signal STV is utilized to control the turn-on time of transistor M3a for controlling the brightness emitted from display panel 22.

For example, referring again to FIG. 3, preset signal STV1 is generated while brightness emitted from light-emitting elements of display panel 22 is changed from bright to dark. Scan driver 262 provides driving signal SC1 according to preset signal STV1 shown in FIG. 3. In this embodiment, driving signal SC1 is equal to preset signal STV1. When the gate of transistor M3a receives driving signal SC1, turn-on time of electroluminescent element ELa is longer than the turn-off time of electroluminescent element ELa. Thus, brightness emitted from display panel 22 is high. Preset signal STV2 is generated while brightness of light emitted from the light-emitting elements of display panel 22 is changed from dark to bright. Scan driver 262 provides driving signal SC1 according to preset signal STV2 shown in FIG. 3. In this embodiment, driving signal SC1 is equal to preset signal STV2. When the gate of transistor M3a receives driving signal SC1, turn-off time of electroluminescent element ELa is longer than turn-on time of electroluminescent element ELa. Therefore, brightness emitted from display panel 22 is low.

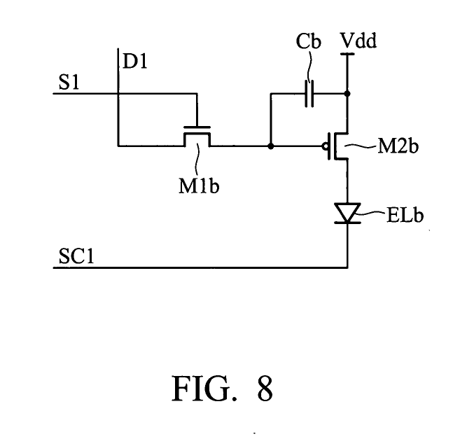

FIG. 8 is a schematic diagram of another embodiment of a pixel. As transistor M1b is turned on, capacitor Cb can be charged. When voltage stored in capacitor Cb is sufficient to turn on transistor M2b, an anode of electroluminescent element ELb receives high voltage Vdd.

When driving signal SC1 is at a low logic level, electroluminescent element ELb emits light. When driving signal SC1 is at a high logic level, electroluminescent element ELb does not emit light.

For example, reference with FIG. 5 and FIG. 8, preset signal STV1 is generated as environmental brightness is low. Scan driver 262 provides driving signal SC1 according to preset signal STV1 shown in FIG. 5. In this embodiment, driving signal SC1 is equal to preset signal STV1. When the anode of electroluminescent element ELb receives STV1, turn-off time of electroluminescent element ELb is longer than turn-on time of electroluminescent element ELb. Therefore, brightness emitted from display panel 22 is low when environmental brightness is low. Preset signal STV2 is generated as brightness emitted from an environment is bright. Scan driver 262 provides driving signal SC1 according to preset signal STV2 shown in FIG. 5. In this embodiment, driving signal SC1 is equal to preset signal STV2. When the anode of electroluminescent element ELb receives STV1, turn-on time of electroluminescent element ELa is longer than turn-off time of electroluminescent element ELb. Therefore, brightness emitted from display panel 22 is high.

As described previously, signal generator 24 controls a duty cycle of a preset signal according to brightness of environmental light and/or of light of a light-emitting element. When the signal generator 24 is utilized in an electronic system comprising a display panel, if the signal generator 24 detects environmental brightness, brightness of the display panel is changed accordingly. If the signal generator 24 detects brightness of light emitted from the light-emitting element, aging of the light-emitting element can be mitigated.

While the invention has been described by way of example and in terms of embodiments, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for controlling brightness of displayed images comprising:
a signal generator, comprising:
a control unit outputting a reference voltage according to the brightness of light emitted during a first period and outputting a reference signal during a second period;
a first processing unit comprising a first input terminal and a first output terminal, wherein a voltage of the first input terminal is equal to that of the first output terminal during the first period and a logic level of the first output terminal is inverse to a logic level of the first input terminal; and
a storage unit storing a response voltage according to the reference voltage and the voltage of the first input terminal during the first period and controlling the logic level of the first input terminal according to the reference voltage and the response voltage during the second period.

2. The system as claimed in claim 1, wherein the control unit comprises:
a photo-detection device providing the reference voltage according to the brightness of the light emitted; and
a selection device outputting the reference voltage during the first period and outputting the reference signal during the second period.

3. The system as claimed in claim 2, wherein the reference signal is a triangular signal.

4. The system as claimed in claim 1, further comprising a light emitting element; and wherein the light is generated by the light-emitting element.

5. The system as claimed in claim 1, wherein the first processing unit comprises:
a switching device turned on during the first period and turned off during the second period; and
an inverting device coupled to the switching device in parallel, wherein a voltage of an input terminal of the inverting device is equal to that of an output terminal of the inverting device as the switching device is turned on and a logic level of the output terminal of the inverting device is inverse to that of the input terminal of the inverting device.

6. The system as claimed in claim 1, wherein the storage unit comprises a capacitor.

7. The system as claimed in claim 1, further comprising a second processing unit comprising a second input terminal coupled to the first output terminal and a second output terminal, wherein the voltage of the first input terminal is equal to that of the second output terminal during the first period and a logic level of the second output terminal is equal to that of the first input terminal during the second period.

8. The system as claimed in claim 7, wherein the first and the second processing units respectively comprise:
a switching device turned on during the first period and turned off during the second period; and
an inverting device coupled to the switching device in parallel, wherein voltage of an input terminal of the inverting device is equal to that of a output terminal of the inverting device as the switching device is turned on and a logic level of the output terminal of the inverting device is inverse to that of the input terminal of the inverting device.

9. The signal generator as claimed in claim 8, wherein the control unit outputs the reference voltage in accordance with a detected brightness of ambient light.

10. A system for controlling brightness of displayed images comprising:
an electronic system comprising:
a display panel comprising a plurality of light-emitting elements; and
a signal generator comprising:
a control unit outputting a reference voltage according to the brightness of light emitted during a first period and outputting a reference signal during a second period:
a first processing unit comprising a first input terminal and a first output terminal, wherein a voltage of the first input terminal is equal to that of the first output terminal during the first period and a logic level of the first output terminal is inverse to a logic level of the first input terminal; and
a storage unit storing a response voltage according to the reference voltage and the voltage of the first input terminal during the first period and controlling the logic level of the first input terminal according to the reference voltage and the response voltage during the second period.

11. The system of claim 10, further comprising a driving device operative to adjust brightness of light emitted from the light-emitting elements according to the logic level of the first output terminal.

12. The system of claim 10, further comprising:
means for adjusting brightness of light emitted from the light-emitting elements according to the logic level of the first output terminal.

13. The system as claimed in claim 10, wherein the signal generator controls the logic level of the first output terminal according to the brightness of light emitted from the light-emitting elements.

14. The system as claimed in claim 10, further comprising the light-emitting elements are string lamps.

15. The system as claimed in claim 10, wherein the signal generator further comprises a second processing unit comprising a second input terminal coupled to the first output terminal and a second output terminal, wherein the voltage of the first input terminal is equal to that of the second output terminal during the first period and a logic level of the second output terminal is equal to that of the first input terminal during the second period and wherein the logic level of the second output terminal is controlled according to brightness of ambient light detected.

16. The system as claimed in claim 14, further comprising a driving device; and wherein the driving device provides a driving signal to the light-emitting element for controlling brightness emitted from the light-emitting element according to the logic level of the second output terminal.

17. The system as claimed in claim 16, wherein the brightness emitted from the light-emitting element is proportional to a detected brightness of ambient light.

18. A system for controlling brightness of displayed images of a display panel, said system comprising:
a control unit operative to adjust brightness of a corresponding display panel based upon at least one of: detected brightness of ambient light and brightness of light emitting elements of the display panel.
